(19) United States
(12) Patent Application Publication
(10) Pub. No.: US 2026/0170047 A1
(43) Pub. Date: Jun. 18, 2026

(54) TERMINAL DEVICE, PROCESSING SYSTEM, AND PROCESSING METHOD FOR DISPLAYING CONTENT TO SPECIFIC AUDIENCES

(71) Applicant: INDUSTRIAL TECHNOLOGY RESEARCH INSTITUTE, Hsinchu (TW)

(72) Inventors: Yao-Yuan Chang, Hsinchu City (TW); Chuan-Kai Lin, Taipei City (TW); Po-Ya Lin, Hsinchu City (TW)

(73) Assignee: INDUSTRIAL TECHNOLOGY RESEARCH INSTITUTE, Hsinchu (TW)

(21) Appl. No.: 18/980,548

(22) Filed: Dec. 13, 2024

(51) Int. Cl. G06F 16/435; G06F 16/438; G06T 11/60; G06V 20/52

(52) U.S. Cl. CPC G06F 16/435; G06F 16/438; G06T 11/60; G06V 20/52

(57) ABSTRACT

A terminal device, a processing system, and a processing method for displaying content to specific audiences are provided. The processing system includes a sensing device, an output device, and a server. The sensing device acquires specific audience information. The output device plays original display information or an output result. The server is connected to the sensing device and the output device and has the original display information and an AI adjustment model, where the original display information has a plurality of content blocks. The server drives the AI adjustment model according to the specific audience information. The AI adjustment model selects at least one content block according to the specific audience information and adjusts a selected content block to an adjusted block. The server generates the output result according to the adjusted block and the rest of the content blocks. The server sends the output result to the output device.

### TECHNICAL FIELD

The present disclosure relates to an electronic device, a processing system, and a processing method, and in particular to a terminal device, processing system and processing method for displaying content to specific audiences.

### BACKGROUND

With the rapid development of technology, carriers that can present content in exhibitions are becoming increasingly diverse. In the early days, the content is presented in the form of posters, or exhibits with texts or images. At present, more diverse exhibited content can be presented via display screens or projections.

Limited by many conditions, curators could only provide a single style of exhibited content for most visitors to read. In certain circumstances, the same exhibited content cannot meet the needs of different visitors. For example, adult visitors can understand the text description of the exhibit. But for preschool children, the text description of the exhibit still cannot make the children understand its content quickly.

### SUMMARY

In view of this, in an embodiment, a processing system for displaying content to specific audiences includes a sensing device, an output device, and a server. The sensing device acquires specific audience information; the output device plays original display information or an output result; the server is connected to the sensing device and the output device; the server has the original display information and an AI adjustment model, where the original display information has a plurality of content blocks; the server drives the AI adjustment model according to the specific audience information; the AI adjustment model selects at least one content block according to the specific audience information and adjusts a selected content block to an adjusted block; the server generates the output result according to the adjusted block and the rest of the content blocks; and the server sends the output result to the output device.

In an embodiment, a terminal device for displaying content to specific audiences acquires an adjusted block generated by a server, and includes a communication unit, a network unit, a storage unit, and a processing unit. The communication unit receives specific audience information; the network unit is connected to the server and receives the adjusted block, or sends an update prompt information; the storage unit stores original display information and a generative dialog model, where the original display information has a plurality of content blocks; the processing unit is connected to the communication unit, the network unit and the storage unit, and executes the generative dialog model, the generative dialog model generates the update prompt information according to the specific audience information, and the update prompt information matches at least one content block; the processing unit drives the network unit to send the update prompt information to the server, the server adjusts corresponding content blocks according to the update prompt information, and adjusted content blocks are the adjusted blocks; and the processing unit generates an output result according to the adjusted blocks and the rest of the content blocks.

In an embodiment, the terminal device for displaying content to specific audiences includes a communication unit, a storage unit, and a processing unit. The communication unit receives specific audience information; the storage unit stores original display information, a generative dialog model, and an AI adjustment model, where the original display information has a plurality of content blocks; the processing unit is connected to the communication unit and the storage unit, and executes the generative dialog model or the AI adjustment model; the generative dialog model generates update prompt information according to the specific audience information; the AI adjustment model selects at least one content block according to the update prompt information, and adjusts a selected content block to an adjusted block; and the processing unit generates an output result according to the adjusted block and the rest of the content blocks.

In an embodiment, a processing method for displaying content to specific audiences includes the following steps of acquiring, by a sensing device, specific audience information of a viewer, and sending the specific audience information to a computer device; executing, by the computer device, an AI adjustment model according to the specific audience information; selecting, by the AI adjustment model, at least one content block from original display information according to the specific audience information, and adjusting a selected content block to an adjusted block; and generating, by the computer device, the output result according to the adjusted block and the rest of the content blocks.

### BRIEF DESCRIPTION OF THE DRAWINGS

FIG. 1 is a schematic diagram of a display venue according to an embodiment.

FIG. 2 is a schematic diagram of a processing system for displaying content to specific audiences according to an embodiment.

FIG. 3 is a schematic diagram of a processing flow for displaying content to specific audiences according to an embodiment.

FIG. 4 is a schematic diagram of a display venue and a processing system according to an embodiment.

FIG. 5 is a picture schematic diagram of original display information according to an embodiment.

FIG. 6A is a picture schematic diagram of an output result according to an embodiment.

FIG. 6B is a picture and voice schematic diagram of an output result according to an embodiment.

FIG. 7 is a schematic diagram of a processing system for displaying content to specific audiences according to an embodiment.

FIG. 8 is a schematic diagram of a processing system for displaying content to specific audiences according to an embodiment.

FIG. 9 is a schematic diagram of a terminal device for displaying content to specific audiences according to an embodiment.

FIG. 10 is a schematic diagram of a changed adjusted block of a computer device in a server according to an embodiment.

FIG. 11 is a schematic diagram of a terminal device for displaying content to specific audiences according to an embodiment.

### DETAILED DESCRIPTION

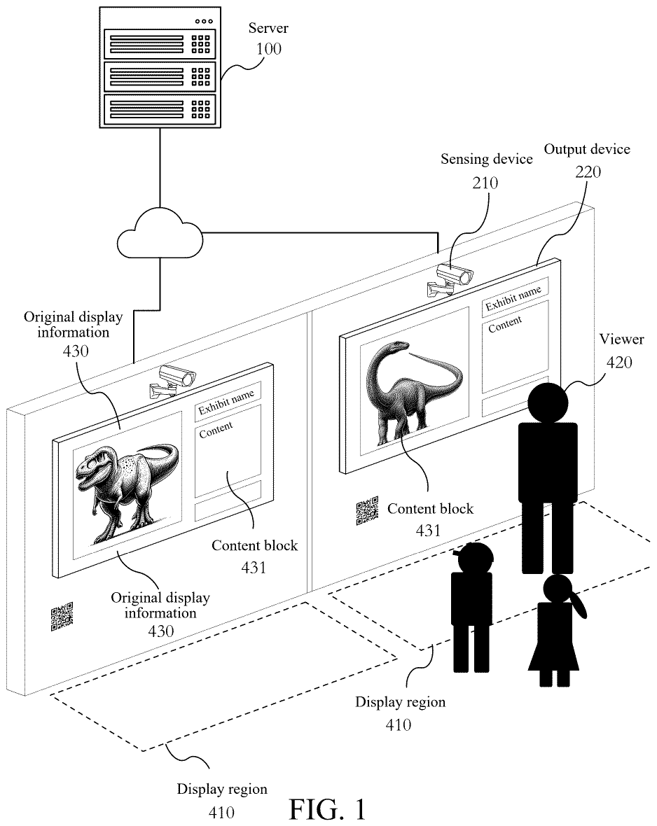

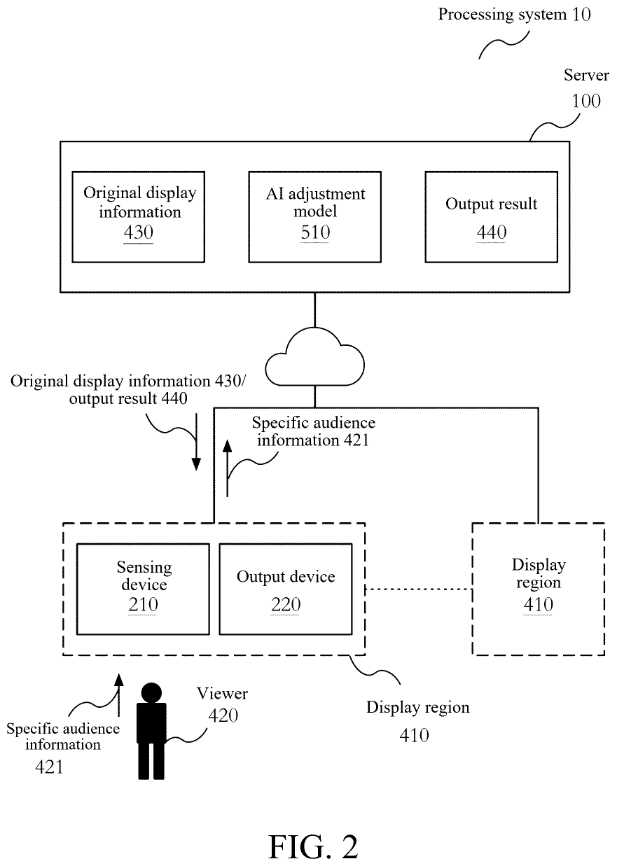

As shown in FIG. 1 and FIG. 2, FIG. 1 and FIG. 2 are a schematic diagram of a display venue according to an embodiment and a schematic diagram of a processing system 10 for displaying content to specific audiences according to an embodiment, respectively. The processing system 10 for displaying content to specific audiences (hereinafter referred to as the processing system 10) can be applied to sites that require guide instructions, e.g., museums, display regions, or department stores. Hereinafter, the site will be collectively referred to as the display venue, and the display venue has at least one display region 410. Each display region 410 has default display content. Hereafter, the preset display content will be referred to as original display information 430. In FIG. 1 and FIG. 2, different display regions 410 are represented with dashed boxes. Furthermore, in order to distinguish visitors at different locations, visitors located in the display region 410 are referred to as viewers 420, and those located outside the display region 410 are referred to as visitors. References are made to the display region 410 on the right side in FIG. 1.

The processing system 10 includes a sensing device 210, an output device 220, and a server 100. The server 100 is connected to the sensing device 210 and the output device 220. By way of examples, the server 100 may be connected to the sensing device 210 or the output device 220 via a network (e.g., a local-area network or the Internet), or connected to the sensing device 210 or the output device 220 via a data cable. At least one sensing device 210 and an output device 220 are configured in each display region 410. The sensing device 210 is configured to detect the viewers 420 in the display region 410 and acquire specific audience information 421 of the viewers 420.

The server 100 has at least one piece of original display information 430 and an artificial intelligence (AI) adjustment model. Each piece of original display information 430 matches a corresponding display region 410 and a corresponding specific viewer 420 group. In other words, each display region 410 has its own original display information 430. An AI adjustment model 510 is configured to adjust the original display information 430 according to the specific audience information 421 to obtain a new output result 440. The types of the AI adjustment model 510 may be, but are not limited to, a generative adversarial network (GAN) model, a natural language processing (NLP) model, a computer vision model, a sentiment analysis model, a knowledge graph model, a reinforcement learning model or a multimodal model.

The server 100 may be an independent computer device 110, which can be configured in a display venue or a cloud. Furthermore, the server 100 may also be a computer device 110 of a cluster. If the server is a server 100 of the cluster, the server 100 can deploy the aforementioned data in different computer devices 110. Furthermore, the server 100 can also provide related information about each display region 410 to a client side of a third party. By way of examples, the server 100 executes a web dashboard to display the sensing device 210, the output device 220, or the original display information 430 in the display region 410 in a dashboard interface.

The types of the sensing device 210 may be, but are not limited to, a camera, a microphone, a near-field communication (NFC) protocol device, a radio-frequency identification (RFID) device or the like. The types of the specific audience information 421 may be age, voice, gender, nationality, membership, exhibition viewing history, viewing preference or a combination thereof. By way of examples, the camera can acquire facial features of the viewer 420 to judge the age, gender, or nationality of the viewer 420. Alternatively, the microphone can acquire the voice of the viewer 420 to judge the gender of the viewer 420. Moreover, the sensing device 210 can also obtain information such as the membership or exhibition viewing history of the viewer 420 with an NFC tag. The sensing device 210 transmits the specific audience information 421 to the server 100. The server 100 can judge the sensing device 210 and the display region 410 to which the sensing device belongs according to a device code of the sensing device 210, e.g., a media access control (MAC) code of a network interface.

The output device 220 may be a liquid crystal display screen, a projection screen, a speaker, or a combination thereof. The output device 220 is configured to play display content provided by the server 100. The display content provided by the server 100 has at least one content block 431. In some embodiments, the types of the content block 431 include text, an image, a three-dimensional model, a video, a sound, or a combination thereof. Portions of text may be static text, e.g., a title, a subtitle, explanatory text, or instantly generated text content.

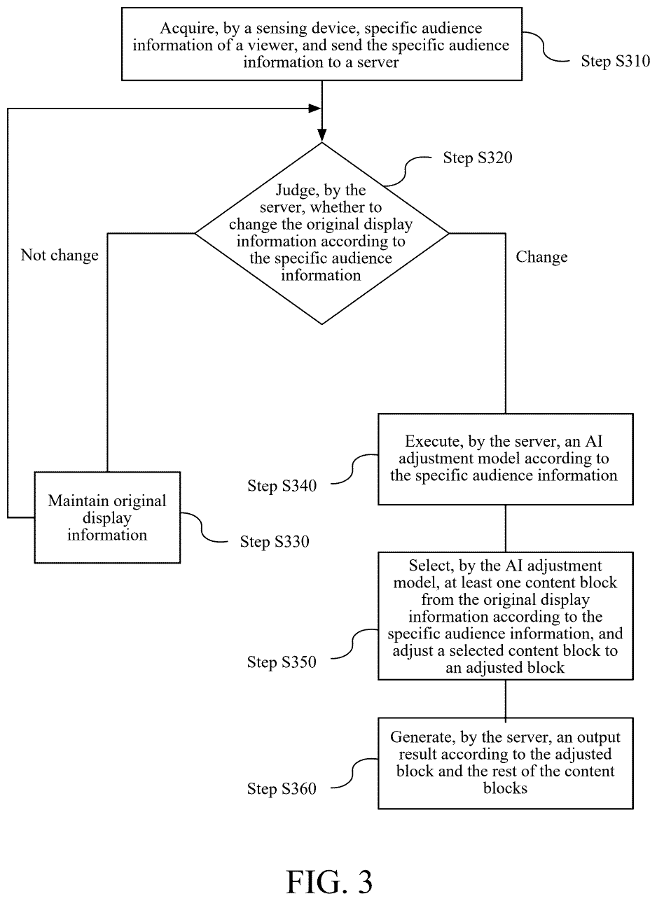

Under a preset condition, the output device 220 plays the original display information 430, as shown in FIG. 1. When the sensing device 210 detects that there is no one in the display region 410, the server 100 can output the original display information 430 to the output device 220. To further illustrate a processing process for displaying content to specific audiences, please refer to FIG. 3. A processing flow for displaying content to specific audiences includes the following steps:
step S310: acquiring, by a sensing device, specific audience information of a viewer, and sending the specific audience information to a server;
step S320: judging, by the server, whether to change original display information according to the specific audience information;
step S330: judging, by the server, not to change the original display information, that is, maintain the original display information;
step S340: judging, by the server, to change the original display information, and execute, by the server, an AI adjustment model according to the specific audience information;
step S350: selecting, by the AI adjustment model, at least one content block from the original display information according to the specific audience information, and adjust a selected content block to an adjusted block; and
step S360: generating, by the server, an output result according to the adjusted block and the rest of the content blocks.

In an initial stage, the server 100 is connected to the sensing device 210 and the output device 220 in each display region 410. After the server 100 confirms a connection status with each sensing device 210 and each output device 220, the server 100 provides the original display information 430 to the output device 220. The initial stage may be the opening of the display venue or its opening each day.

When the viewers 420 enter the display region 410, the sensing device 210 belonging to the display region 410 will acquire the specific audience information 421 of the viewers 420 (corresponding to step S310). The sensing device 210 transmits the acquired specific audience information 421 to the server 100. Taking FIG. 1 as an example, a camera is configured in the display region 410. Therefore, the sensing device 210 (corresponding to the aforementioned camera) regards a captured image of the viewer 420 or his/her facial image as the specific audience information 421. Moreover, in the display region 410 on the right side of FIG. 1, there are adult viewers 420. The sensing device 210 captures a digital image (corresponding to the specific audience information 421) of the viewer 420, and transmits the specific audience information 421 to the server 100.

Furthermore, a card reader (corresponding to the sensing device 210) can be arranged in the display region 410, and the viewer 420 can move a personal vehicle (e.g., a mobile phone or a membership card) to the card reader, so that the card reader can read the specific audience information 421 in the personal vehicle. Alternatively, an application of a corresponding display venue can be configured in the mobile phone of the viewer 420, and a quick response code (QR code) of the display region 410 can be captured with the mobile phone. The application can send the specific audience information 421 to the server 100.

The server 100 judges whether the original display information 430 needs to be changed according to the specific audience information 421 (corresponding to step S320). It is assumed that preset audiences in this display venue are an adult. If the server 100 judges the viewers 420 in FIG. 1 as the “adult”, the server 100 will not change the original display information 430 of the display region 410 (corresponding to step S330).

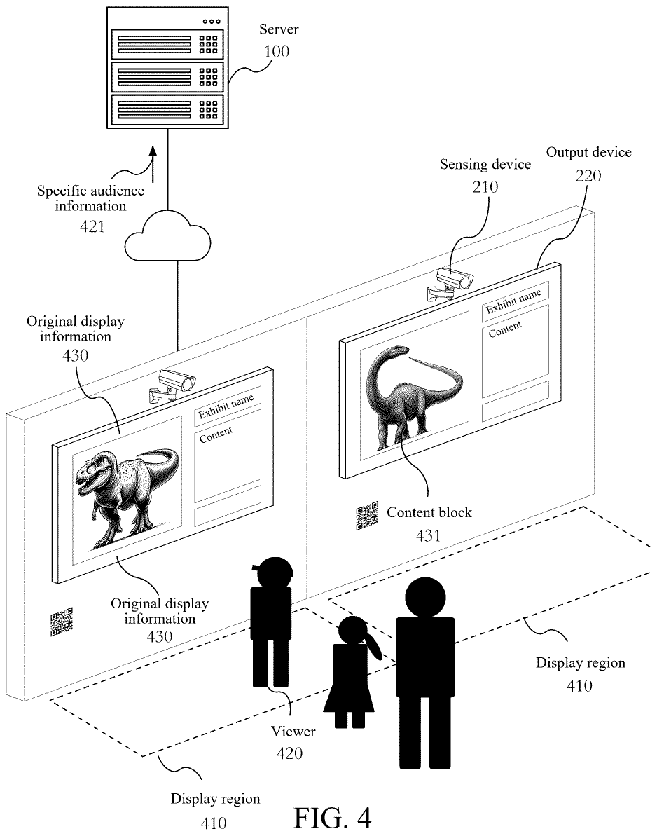

When the viewers 420 in the display region 410 does not belong to the “adult” range, the server 100 will change the original display information 430 according to the specific audience information 421. Referring to FIG. 4, the viewers 420 included in the display region 410 on the left side of FIG. 4 do not belong to the “adult” range. Therefore, the server 100 executes the AI adjustment model 510 according to the specific audience information 421 (corresponding to step S340) to adjust the original display information 430. The AI adjustment model 510 judges the comprehension range of the viewer 420 according to the specific audience information 421. The specific audience information 421 may include, but is not limited to, information such as age and gender. These pieces of information may serve as a basis for judging the selection of the content blocks 431. Furthermore, the processing unit 234 can also select a corresponding prompt according to the specific audience information 421, and then input a selected prompt into the AI adjustment model 510.

Next, the AI adjustment model 510 select at least one content block 431 from the original display information 430 as a potential object to be adjusted. The AI adjustment model 510 further check whether the selected content block 431 conform to the specific audience information 421 of the viewer 420. Specifically, the AI adjustment model 510 can traverse the content blocks 431 in the original display information 430 one by one to determine whether each content block 431 meets the criteria related to the specific audience information 421, for example, whether each content block is suitable for the age range or comprehension ability of the viewer 420.

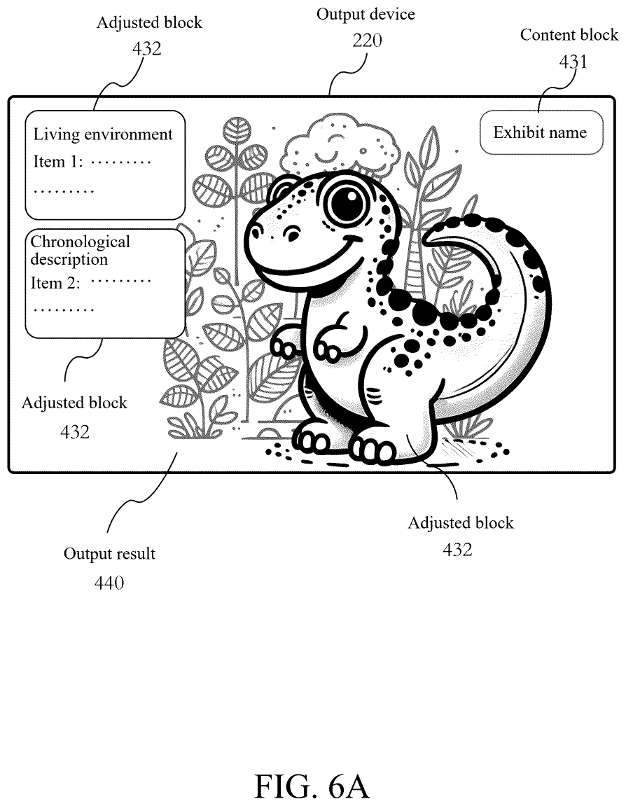

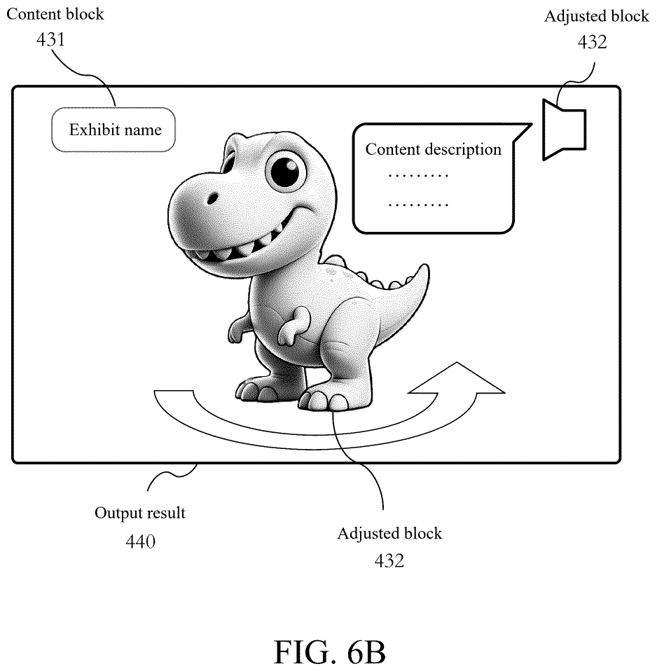

If certain content blocks 431 are judged as not meeting the needs of viewers 420, the AI adjustment model 510 will select these content blocks 431 as targets to be adjusted, and modify their content to generate adjusted content blocks 431 that conform to the specific audience information 421 (corresponding to step S350). Finally, the server 100 packages all the adjusted content blocks 431 into the output result 440. The server 100 sends the output result 440 to the output device 220 for the viewers 420 in the display region 410 to view, as shown in FIG. 6A.

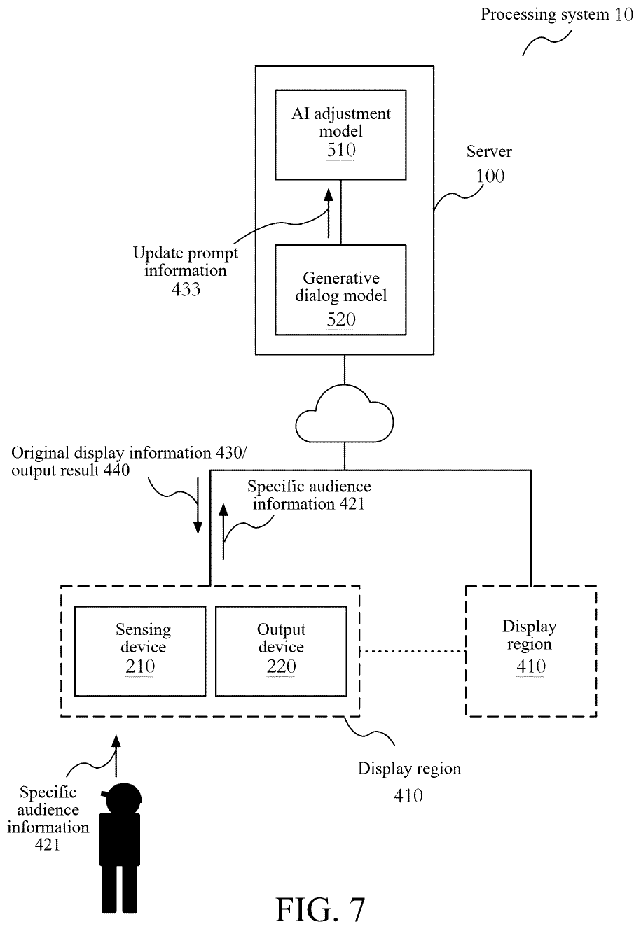

In some embodiments, the server 100 further includes a generative dialog model 520 (Generative AI), as shown in FIG. 7. The generative dialog model 520 is connected to the AI adjustment model 510. The generative dialog model 520 may be a large language model or a small language model stored in the server 100, or it can be concatenated to language models from other AI suppliers. The server 100 inputs the specific audience information 421 into the generative dialog model 520, so that the generative dialog model 520 generates update prompt information 433. The update prompt information 433 includes a description of modifications in theme, language, style, structure, culture, emotion, real-time data, historical data, educational goal, interactive goal, format requirement, media type, etc. The AI adjustment model 510 selects a corresponding content block 431 according to all modification requirements of the update prompt information 433, and adjusts the content of a selected content block 431 (i.e., an adjusted block 432).

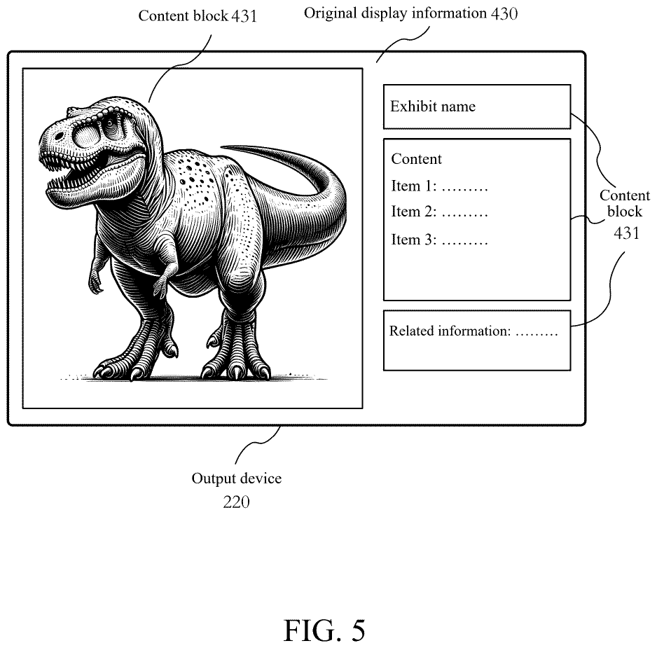

Taking FIG. 4 and FIG. 5 as examples, the generative dialog model 520 judges the viewers 420 in the display region 410 as a “minor” according to the specific audience information 421. The generative dialog model 520 generates corresponding update prompt information 433 for “theme”, “style”, “structure,”, “emotion”, “educational goal”, or “interactive goal”. Next, the generative dialog model 520 sends the update prompt information 433 and the specific audience information 421 to the AI adjustment model 510. The AI adjustment model 510 selects the content block 431 according to the specific audience information 421, and additionally adjusts the selected content block 431 with the update prompt information 433.

By way of examples, one of the display regions 410 in FIG. 4 plays the original display information 430 about “tyrannosaurus”. When there is a “minor” viewer 420 in the display region 410, the sensing device 210 transmits the specific audience information 421 to the AI adjustment model 510. The AI adjustment model 510 can generate prompts from pre-stored prompts or otherwise with other generative artificial intelligence, thereby selecting the content block 431 and generating the output result 440. Therefore, the AI adjustment model 510 adjusts the “tyrannosaurus” (corresponding to the original display information 430) in the display region 410 on the left side of FIG. 4 to a presentation pattern of the original display information 430 meeting the needs of the “minor” viewers 420.

The AI adjustment model 510 also adjusts the content blocks 431 of multiple groups of “text” descriptions in FIG. 5 to different types of content blocks 431 (corresponding to the adjusted block 432) in FIG. 6A, so as to meet the attractiveness and absorption degree of the viewers 420 for displayed content. Further, the sensing device 210 acquires the specific audience information 421 of a lower age, and the server 100 can adjust the content block 431 of the text to the adjusted block 432 of voice. Alternatively, the content block 431 of a flat “tyrannosaurus” picture is adjusted to the adjusted block 432 of a 3D object, as shown in FIG. 6B, so that the viewer 420 at a low age can obtain related content from sounds and movable images. The viewer 420 can control the adjusted block 432 with a controllable output device 220 (e.g., a touch screen).

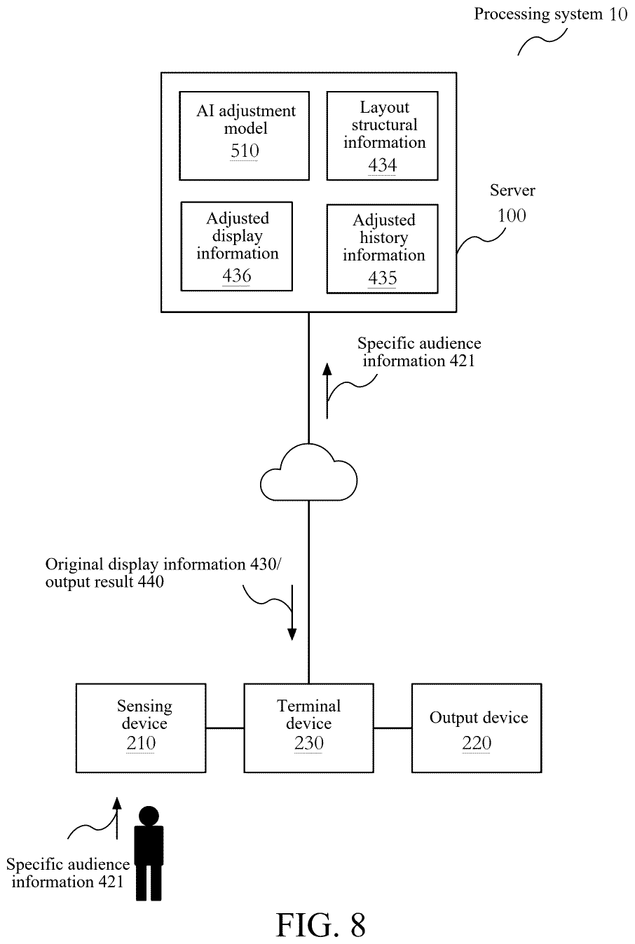

In some embodiments, the processing system 10 further includes a terminal device 230, as shown in FIG. 8. The terminal device 230 may be configured in the display region 410. The terminal device 230 is connected to the sensing device 210 and the output device 220 via signals, and the terminal device 230 is connected to the server 100 via a network. The terminal device 230 forwards the specific audience information 421 to the server 100, or sends the original display information 430 and the output result 440 to the output device 220. The server 100 can determine the display region 410 to which it belongs via a network interface (not shown) of the terminal device 230 and the MAC code.

In some embodiments, the server 100 further stores layout structural information 434 of each piece of original display information 430, as shown in FIG. 8. The layout structural information 434 records a relative position of each content block 431 of the original display information 430. The server 100 adjusts the layout structural information 434 according to the adjusted block 432 and the rest of the content blocks 431, and packages the specific audience information 421 and adjusted layout structural information 434. After that, the server 100 can call corresponding layout structural information 434 or content block 431 or not according to other specific audience information 421. Furthermore, after the server 100 generates the output result 440, the server 100 can also store the layout structural information 434 of the output result 440 to record the position information of the adjusted block 432 and the rest of the content blocks 431.

In some embodiments, the server 100 stores adjusted display information 436 and adjusted history information 435. The adjusted display information 436 is used for recording the content of the adjusted block 432 and the content block 431 in the output result 440, and may also record the layout structural information 434 at the same time. The adjusted history information 435 is used for recording all output results 440, and each output result 440 corresponds to the specific audience information 421 to which it belongs and the adjusted display information 436.

As mentioned above, corresponding output results 440 will be generated for different viewers 420. Therefore, the server 100 can record every output result 440. When the same viewer 420 visits again, the server 100 can call the output result 440 generated previously. Alternatively, the server 100 calls a similar type of the specific audience information 421 and the output result 440 to provide the current viewers 420. By way of examples, the server 100 has recorded the specific audience information 421 of “9-10-year-old” viewers and the adjusted display information 436. When the sensing device 210 acquires other specific audience information 421 of the “9-10-year-old” viewers, the server 100 can call previously recorded adjusted display information 436 to generate the corresponding output result 440. Therefore, between step S320 and step S340, the server 100 can also add the processing of “the server 100 looks up whether there is a corresponding output result 440 according to the specific audience information 421” to judge whether the output result 440 related to the specific audience information 421 has been stored in the server 100.

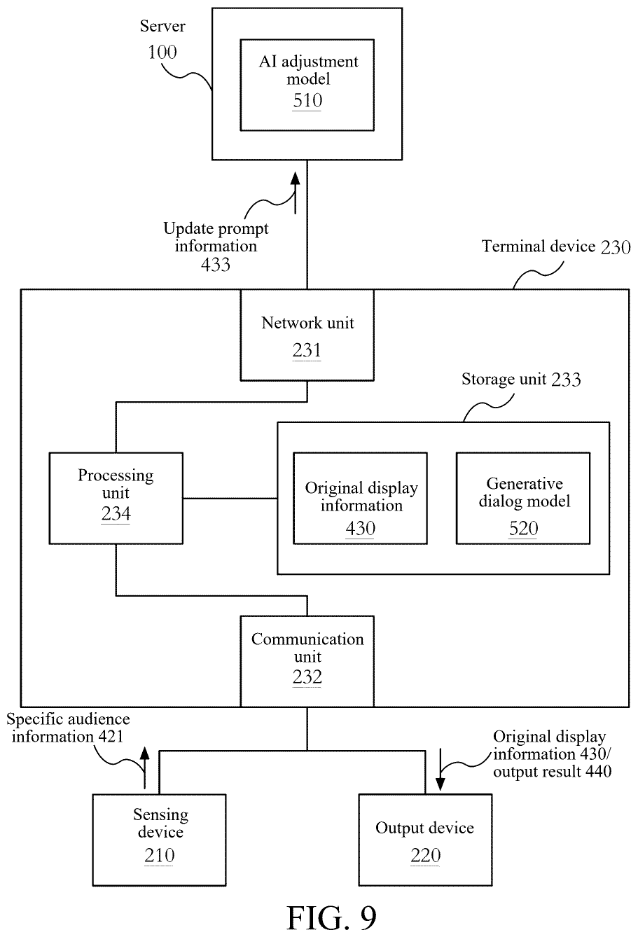

In some embodiments, the processing system 10 includes a server 100, a sensing device 210, an output device 220, and a terminal device 230. The terminal device 230 is connected to the server 100, the sensing device 210 and the output device 220, as shown in FIG. 9. The terminal device 230 has a network unit 231, a communication unit 232, a storage unit 233, and a processing unit 234. The processing unit 234 is connected to the network unit 231, the communication unit 232 and the storage unit 233.

The communication unit 232 is connected to the sensing device 210 and the output device 220. The communication unit 232 receives specific audience information 421 of the sensing device 210, or sends original display information 430 (or an output result 440) to the output device 220. The network unit 231 can be connected to server 100 via a wired network or a wireless network. The network unit 231 receives an adjusted block 432 from the server 100, or sends update prompt information 433 to the server 100. The storage unit 233 stores the original display information 430 and a generative dialog model 520. The server 100 has an AI adjustment model 510, where the AI adjustment model 510 is configured to modify the content of a content block 431 and generate a corresponding adjusted block 432.

After the processing unit 234 receives the specific audience information 421, the processing unit 234 executes the generative dialog model 520. The generative dialog model 520 generates the update prompt information 433 according to the specific audience information 421. The update prompt information 433 matches at least one content block 431 in the original display information 430. The processing unit 234 drives the network unit 231 to send the update prompt information 433 to the server 100, so that the AI adjustment model 510 adjusts the content of a selected content block 431. The server 100 sends an adjusted content block 431 to the terminal device 230. Furthermore, the server 100 adjusts layout structural information 434 according to the update prompt information 433, and sends modified layout structural information 434 to the terminal device 230. The terminal device 230 receives all the adjusted blocks 432 to generate the output results 440.

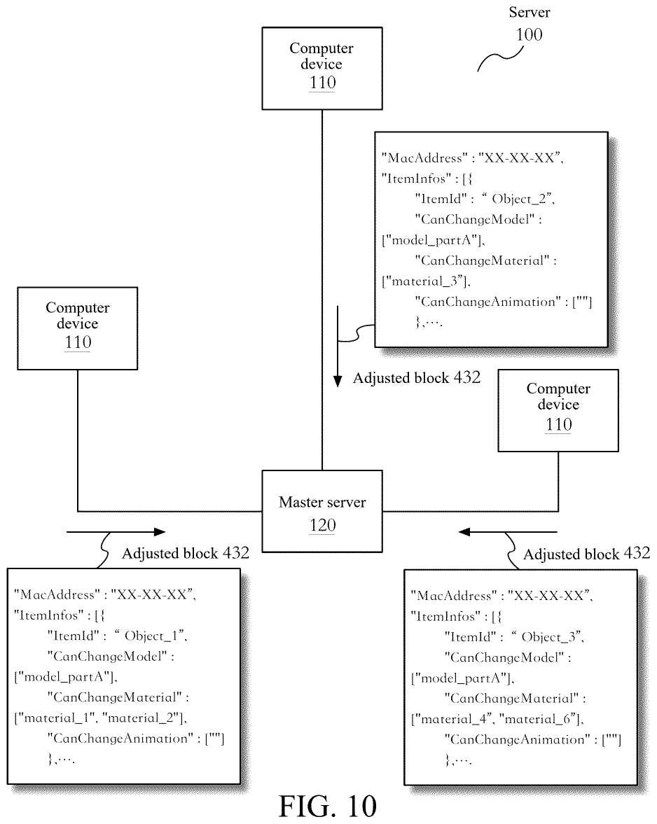

For the server 100 of a cluster, the server 100 can store different content blocks 431 and the corresponding adjusted blocks 432 to different computer devices 110. The AI adjustment model 510 acquires different adjusted blocks 432 from the corresponding computer device 110 according to the specific audience information 421. Taking the “tyrannosaurus” in FIG. 6B as an example, in the server 100, components such as the head, forelimbs, feet, trunk and tail of the “tyrannosaurus” (corresponding to the adjusted blocks 432) can be stored in different computer devices 110, respectively, as shown in FIG. 10. In FIG. 10, a master server 120 and a plurality of computer devices 110 constitute the server 100 of the cluster, but in fact the server 100 can be used in different composition architectures according to the network or hardware application.

After the server 100 receives the same (or similar) specific audience information 421 again, the AI adjustment model 510 can acquire different components (corresponding to the adjusted blocks 432) from the aforementioned computer device 110. The AI adjustment model 510 of the master server 120 in FIG. 10 acquires the adjusted blocks 432 of different components from each computer device 110. For the convenience of representing the content of the adjusted block 432, the belonging components are represented as the adjusted blocks 432 in JSON (JavaScript Object Notation) format in FIG. 10. But not limited to this, the computer device 110 can also be represented by other intermediate languages, e.g., Extensible Markup Language (XML). The master server 120 sends acquired adjusted block 432 and corresponding layout structural information 434 to the terminal device 230.

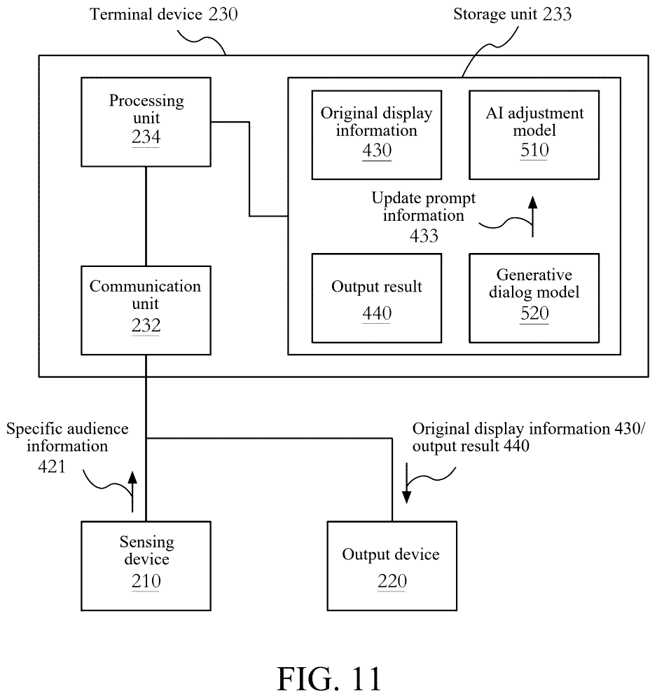

In some embodiments, the processing system 10 includes a terminal device 230, a sensing device 210, and an output device 220. The terminal device 230 is connected to the sensing device 210 and the output device 220, as shown in FIG. 11. The terminal device 230 has a communication unit 232, a storage unit 233, and a processing unit 234. A corresponding terminal device 230 can be configured in each display region 410. The processing unit 234 is connected to the communication unit 232 and the storage unit 233. The communication unit 232 is connected to the sensing device 210 and the output device 220. The communication unit 232 receives specific audience information 421 of the sensing device 210, or sends original display information 430 (or an output result 440) to the output device 220.

The storage unit 233 has the original display information 430, a generative dialog model 520, and an AI adjustment model 510. The sensing device 210 transmits the specific audience information 421 of a viewer 420 to the terminal device 230. The processing unit 234 executes the generative dialog model 520 and the AI adjustment model 510. The generative dialog model 520 generates the update prompt information 433 according to the specific audience information 421. The processing unit 234 sends the update prompt information 433 to the AI adjustment model 510. The AI adjustment model 510 selects at least one content block 431 from the original display information 430 according to the update prompt information 433. The AI adjustment model 510 adjusts the content of a selected content block 431 to generate a corresponding adjusted block 432. The processing unit 234 generates an output result 440 according to the adjusted block 432 and the rest of the content blocks 431. The processing unit 234 drives the communication unit 232, so that the communication unit 232 sends the output result 440 to the output device 220.

The processing system for displaying content to specific audiences generates different display content via generative artificial intelligence in real time, thereby providing the display content meeting the needs of the current viewers. Moreover, the processing system can store the generated display content, which not only can reduce the workload of curators on content processing, but also can increase the richness of exhibited content.

The terminal device 230, processing system 10, and processing method for displaying content to specific audiences can provide different presentation modes of the exhibited content in real time for different groups of viewers 420 to view. The processing system 10 for displaying content to specific audiences can generate the exhibited content meeting the needs of the current viewers 420 via the generative artificial intelligence. Moreover, the generated exhibited content can also be saved, so that other similar viewers 420 can call the reserved exhibited content from the server 100 when viewing.

1. A processing system for displaying content to specific audiences, comprising:
a sensing device, acquiring specific audience information;
an output device, playing original display information or an output result; and
a server, connected to the sensing device and the output device, the server having the original display information and an artificial intelligence (AI) adjustment model, the original display information having a plurality of content blocks, the server driving the AI adjustment model according to the specific audience information, the AI adjustment model selecting at least one content block according to the specific audience information and adjusting content of the selected content block to correspondingly generate an adjusted block, the server generating the output result according to the adjusted block and the rest of the content blocks, and the server sending the output result to the output device.

2. The processing system for displaying content to specific audiences according to claim 1, wherein the server comprises a generative dialog model, and the generative dialog model generates update prompt information according to the specific audience information.

3. The processing system for displaying content to specific audiences according to claim 2, wherein the AI adjustment model selects at least one content block from the original display information according to the update prompt information, and adjusts the selected content block to the adjusted block.

4. The processing system for displaying content to specific audiences according to claim 1, further comprising a terminal device, the terminal device being connected to the sensing device, the output device and the server, and forwarding the specific audience information to the server, and forwarding the output result or the original display information to the output device.

5. The processing system for displaying content to specific audiences according to claim 4, wherein the terminal device has a generative dialog model, the generative dialog model generates update prompt information according to the specific audience information, the terminal device sends the update prompt information to the server, and the server selects the adjusted block from the content blocks according to the update prompt information and generates the output result.

6. The processing system for displaying content to specific audiences according to claim 4, wherein the server sends corresponding original display information or the output result to the terminal device according to a media access code of the terminal device.

7. The processing system for displaying content to specific audiences according to claim 1, wherein the original display information has layout structural information, and the layout structural information records position information of each content block.

8. The processing system for displaying content to specific audiences according to claim 7, wherein after the server completes the adjusted blocks, the server adjusts the layout structural information according to the content blocks and the adjusted blocks, and stores adjusted layout structural information.

9. The processing system for displaying content to specific audiences according to claim 1, wherein the server stores adjusted display information and adjusted history information, the adjusted display information records the adjusted blocks and the rest of the content blocks, and the adjusted history information records the specific audience information and corresponding adjusted display information.

10. The processing system for displaying content to specific audiences according to claim 9, wherein the server receives another specific audience information, searches the adjusted history information according to new specific audience information, and acquires the corresponding adjusted display information from the adjusted history information according to the new specific audience information.

11. The processing system for displaying content to specific audiences according to claim 1, wherein the content block is text, an image, a 3D model, a video, or a sound.

12. A terminal device for displaying content to specific audiences, acquiring an adjusted block generated by a server, and comprising:
a communication unit, receiving specific audience information;
a network unit, connected to the server, and receiving the adjusted block or sending update prompt information;
a storage unit, storing original display information and a generative dialog model, the original display information having a plurality of content blocks; and
a processing unit, connected to the communication unit, the network unit and the storage unit, and executing the generative dialog model, the generative dialog model generating the update prompt information according to the specific audience information, and the update prompt information matching at least one content block, the processing unit driving the network unit to send the update prompt information to the server, the server adjusting content of corresponding content blocks according to the update prompt information, and the adjusted content blocks being the adjusted blocks, and the processing unit generating an output result according to the adjusted blocks and the rest of the content blocks.

13. The terminal device for displaying content to specific audiences according to claim 12, further comprising an output device, connected to the communication unit, and playing the original display information and the output result.

14. The terminal device for displaying content to specific audiences according to claim 12, wherein the storage unit stores adjusted display information and adjusted history information, the adjusted display information records the adjusted blocks and the rest of the content blocks, and the adjusted history information records the specific audience information and corresponding adjusted display information.

15. The terminal device for displaying content to specific audiences according to claim 14, wherein the communication unit receives another specific audience information, and the processing unit searches the adjusted history information according to new specific audience information, and acquires the corresponding adjusted display information from the adjusted history information according to the new specific audience information.

16. A terminal device for displaying content to specific audiences, comprising:
a communication unit, receiving specific audience information;
a storage unit, storing original display information, a generative dialog model, and an AI adjustment model, the original display information having a plurality of content blocks; and
a processing unit, connected to the communication unit and the storage unit, and executing the generative dialog model or the artificial intelligence (AI) adjustment model, the generative dialog model generating update prompt information according to the specific audience information, the AI adjustment model selecting at least one content block according to the update prompt information, and adjusting content of the selected content block to correspondingly generate an adjusted block, and the processing unit generating an output result according to the adjusted block and the rest of the content blocks.

17. The terminal device for displaying content to specific audiences according to claim 16, further comprising an output device, connected to the communication unit, and playing the original display information and the output result.

18. The terminal device for displaying content to specific audiences according to claim 16, wherein the storage unit stores adjusted display information and adjusted history information, the adjusted display information records the adjusted blocks and the rest of the content blocks, and the adjusted history information records the specific audience information and corresponding adjusted display information.

19. The terminal device for displaying content to specific audiences according to claim 18, wherein the communication unit receives another specific audience information, and the processing unit searches the adjusted history information according to new specific audience information, and acquires the corresponding adjusted display information from the adjusted history information according to the new specific audience information.

20. A processing method for displaying content to specific audiences, providing a corresponding output result to a viewer, and comprising:
acquiring, by a sensing device, specific audience information of the viewer, and sending the specific audience information to a computer device;
executing, by the computer device, an artificial intelligence (AI) adjustment model according to the specific audience information;
selecting, by the AI adjustment model, at least one content block from original display information according to the specific audience information, and adjusting content of the selected content block to correspondingly generate an adjusted block; and
generating, by the computer device, the output result according to the adjusted block and the rest of the content blocks.
